(19) United States
(12) Patent Application Publication
(10) Pub. No.: US 2006/0015753 A1
(43) Pub. Date: Jan. 19, 2006

(54) Internal RAM for integrity check values

(75) Inventors: Robert A. Drehmel, Goodhue, MN (US); William E. Hall, Clinton, CT (US); Russell D. Hoover, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(73) Assignee: International Business Machines Corporation, Armonk, NY (US)

(21) Appl. No.: 10/892,430

(22) Filed: Jul. 15, 2004

(51) Int. Cl. G06F 12/14; H04L 9/32; G06F 11/30

(52) U.S. Cl. 713/193

(57) ABSTRACT

Methods and apparatus that may be utilized to reduce the amount of data related to encryption (hereinafter security metadata) that is accessible external to a device implementing the encryption, such as a system on a chip (SOC), are provided. The security metadata may be stored internal, for example in a secure random access memory (RAM) internal to the device, that is not accessible via external pins.

### BACKGROUND OF THE INVENTION

1. Field of the Invention

The present invention generally relates to data encryption and, more particularly, to methods and apparatus for reducing the amount of security metadata, such as integrity check values, that is accessible external to a device.

2. Description of the Related Art

A system on a chip (SOC) generally includes one or more integrated processor cores, some type of embedded memory, such as a cache shared between the processors cores, and peripheral interfaces, such as memory control components and external bus interfaces, on a single chip to form a complete (or nearly complete) system. The use of cache memory hierarchies is well established to improve a processor performance by reducing and/or eliminating read access requests to external main memory.

As part of an enhanced security feature, some SOCs encrypt some portions of data prior to storing it in external memory. Adding such encryption to an SOC may add valuable benefits, such as preventing a hacker from obtaining instructions of a copyrighted program, such as a video game, or data that may be used to determine such instructions through reverse engineering. When the encrypted data is subsequently retrieved from external memory, it must first be decrypted before it can be used by the processor cores.

In some cases, in an effort to detect tampering with the encrypted data, some type of integrity check value may be generated, as a function of the data, either prior to or after encryption. When the encrypted data is retrieved, a new integrity check value is generated (e.g., prior to or after decrypting the data depending on how the previously stored integrity check value was calculated) and compared against the previously generated integrity check value. A mismatch between the two indicates the encrypted data has been tampered with.

In conventional systems, the integrity check values are encrypted and stored with the encrypted data, in external memory. Thus, though encrypted, the integrity check values are exposed and, in some cases, may be accessible to hackers and prone to attack. For example, a hacker may attempt a so-called “replay attack” in which a large block of memory, including the integrity check values, is copied and later used to replace an existing block. Alternatively, a hacker may attempt a so-called “relocation attack” where a large block of memory, including the integrity check values, is copied to a different location in memory. In any case, because the integrity check values are copied, if the right portions are copied properly, the block of memory may be validated when read back from memory and, thus, this type of attack may go undetected.

Accordingly, in some cases, it may be preferable to keep these integrity check values internal to the SOC, inaccessible via external pins, and, thus inaccessible to a hacker.

### SUMMARY OF THE INVENTION

The present invention generally provides a method and apparatus that may be used to detect tampering with encrypted data, without providing a hacker with access to security metadata, such as integrity check values.

One embodiment provides a method of handling secure data passed between a processor and memory external to the processor. The method generally includes receiving a secure block of data to be written to the memory external to the processor, encrypting the secure block of data, generating a first integrity check value as a function of the received block of secure data, storing the secure block of data, in encrypted form, in the memory external to the processor, and storing the first integrity check value in memory internal to the processor.

Another embodiment provides a method of handling data passed between a processor and memory external to the processor. The method generally includes receiving a block of data to be written to the memory external to the processor, determining if the block of data is secure, and, if the block of data is not secure, writing the block of data to the memory external to the processor. The method further includes, if the block of data is secure, encrypting the secure block of data, generating an integrity check value as a function of the received block of secure data, storing the secure block of data, in encrypted form, in the memory external to the processor, and storing the integrity check value in memory internal to the processor.

Another embodiment provide a device for encrypting blocks of data to be stored in memory external to the device. The device generally includes an internal random access memory (RAM), an encryption engine configured to encrypt secure blocks of data to be stored in the external memory, and a validation component. The validation component is generally configured to generate integrity validation codes as a function of secure blocks of data and store the integrity validation codes in the internal RAM.

Another embodiment provides a system on a chip (SOC) generally including one or more processor cores, a cache accessible by the one or more processor cores, an internal random access memory (RAM), wherein the internal RAM is not accessible externally from the SOC, an encryption engine configured to encrypt secure blocks of data received from the cache and to be stored in the external memory, and a validation component. The validation component is generally configured to generate integrity validation codes as a function of secure blocks of data and store the integrity validation codes in the internal RAM.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 illustrates an exemplary system including a CPU, in which embodiments of the present invention may be utilized.

FIG. 2 is a block diagram illustrating data flow through the CPU, according to one embodiment of the present invention.

FIG. 3 is a flow diagram of exemplary operations for writing encrypted data according to one embodiment of the present invention.

FIG. 4 is a flow diagram of exemplary operations for reading encrypted data according to one embodiment of the present invention.

FIG. 5 is a block diagram illustrating location-sensitive integrity check values, according to one embodiment of the present invention.

### DETAILED DESCRIPTION OF THE PREFERRED EMBODIMENTS

Embodiments of the present invention may be utilized in systems to reduce the amount of data related to encryption (hereinafter security metadata) that is accessible external to a device implementing the encryption, such as a system on a chip (SOC). Rather than store security metadata along with encrypted data in external memory, the security metadata may be stored internal, for example in a secure random access memory (RAM) internal to the device, that is not accessible via external pins. As a result, a hacker may not be able to access the security metadata and, thus, may be prevented from using the security metadata to facilitate attacks on the system.

As used herein, the term security metadata generally refers to any type of data used during the encryption process. For example, security metadata may include such data as encryption keys, version numbers, and the like, used to encrypt data. While security metadata may include all of these types of data, to facilitate understanding, the following description will refer to integrity check values as a specific, but not limiting example, of the type of security metadata that may be advantageously stored internally to a device.

As used herein, the term secure data refers to data that is to be encrypted when stored external to an encryption-enabled device, such as an SOC, while the term non-secure data refers to data that may be stored externally in non-encrypted form. Data that is non-encrypted (whether secure or non-secure) is referred to herein as plaintext while data that is encrypted is referred to herein as ciphertext. These terms are used for convenience and do not imply the encrypted or non-encrypted data is actually textual data. In other words, plaintext or ciphertext may include any type of data, such as processor instructions and any data involved therein.

Further, in the following description, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and, unless explicitly present, are not considered elements or limitations of the appended claims

### An Exemplary System

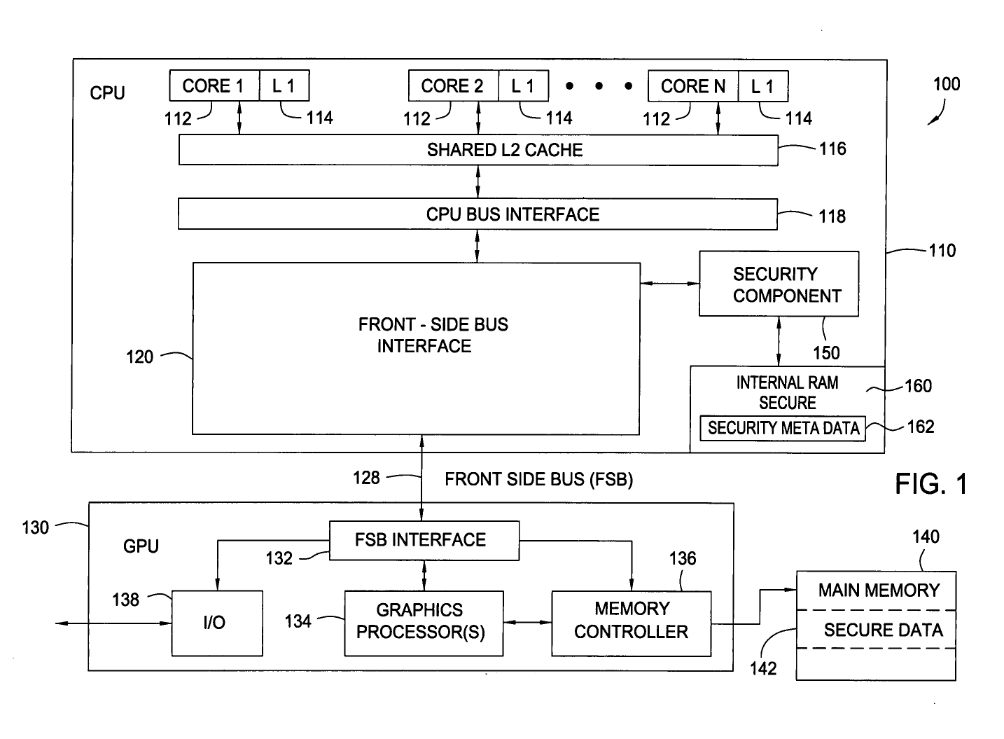

Referring now to FIG. 1, an exemplary computer system 100 including a central processing unit (CPU) 110 is illustrated, in which embodiments of the present invention may be utilized. As illustrated, the CPU 110 may include one or more processor cores 112, which may each include any number of different type functional units including, but not limited to arithmetic logic units (ALUs), floating point units (FPUs), and single instruction multiple data (SIMD) units. Examples of CPUs utilizing multiple processor cores include the PowerPC® line of CPUs, available from International Business Machines (IBM) of Armonk, N.Y.

As illustrated, each processor core 112 may have access to its own primary (L1) cache 114, as well as a larger shared secondary (L2) cache 116. In general, copies of data utilized by the processor cores 112 may be stored locally in the L2 cache 116, preventing or reducing the number of relatively slower accesses to external main memory 140. Similarly, data utilized often by a processor core 112 may be stored in its L1 cache 114, preventing or reducing the number of relatively slower accesses to the L2 cache 116.

The CPU 110 may communicate with external devices, such as a graphics processing unit (GPU) 130 and/or a memory controller 136 via a system or frontside bus (FSB) 128. The CPU 110 may include an FSB interface 120 to pass data between the external devices and the processing cores 112 (through the L2 cache) via the FSB 128. An FSB interface 132 on the GPU 130 may have similar components as the FSB interface 120, configured to exchange data with one or more graphics processors 134, input output (I/O) unit 138, and the memory controller 136 (illustratively shown as integrated with the GPU 130).

The FSB interface 120 may include any suitable components, such as a physical layer (not shown) for implementing the hardware protocol necessary for receiving and sending data over the FSB 128. Such a physical layer may exchange data with an intermediate “link” layer which may format data received from or to be sent to a transaction layer. The transaction layer may exchange data with the processor cores 112 via a core bus interface (CBI) 118.

### Secure Data Processing

As part of an enhanced security feature, the CPU 110 may encrypt some portions of data, referred to herein as secure data, prior to storing it in main memory 140 (such encrypted portions of data are illustratively shown as secure data 142 in main memory 140). Accordingly, the CPU 110 may include a security component 150 used to encrypt secure data prior to transmission over the FSB 128 by the FSB interface 120. Upon later retrieval of the encrypted data, the security component 150 may also be used to decrypt the encrypted secure data prior to passing it into the L2 cache 116 for use by one or more of the processor cores 112. The security component 150 may employ any suitable encryption algorithms or combination of algorithms for encryption/decryption, including, but not limited to algorithms utilizing whitening keys, hash keys, and/or Advanced Encryption Standard (AES) keys.

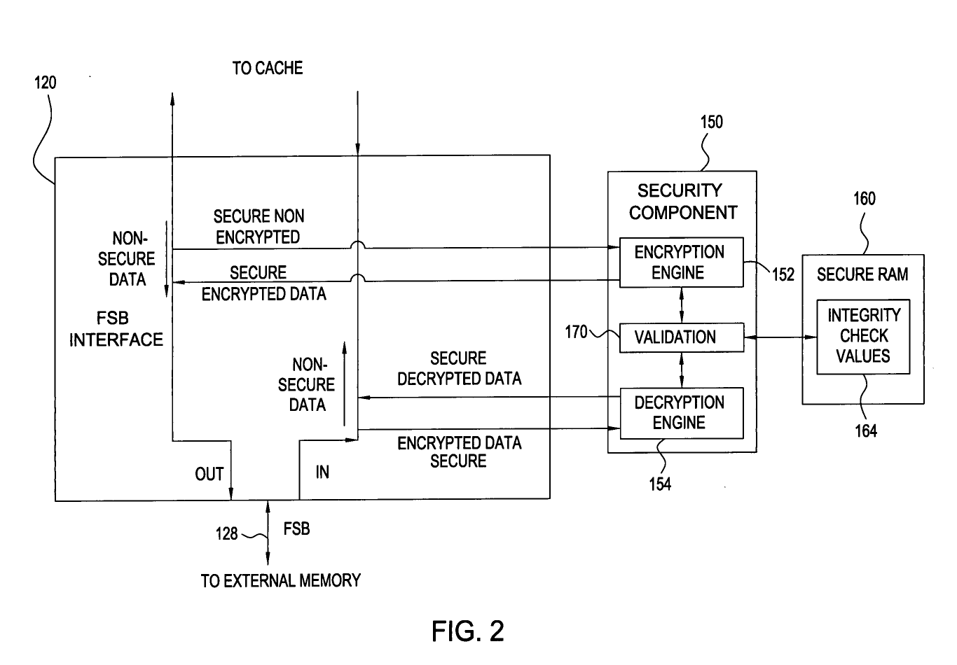

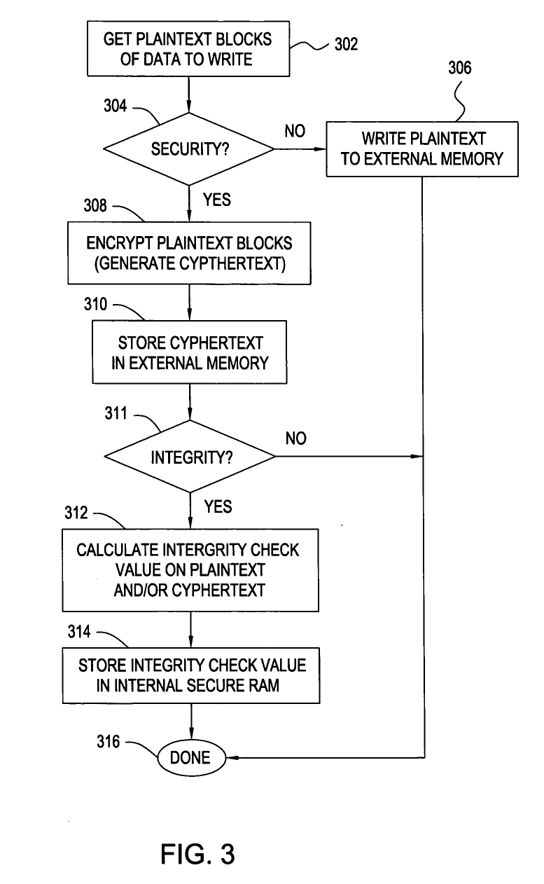

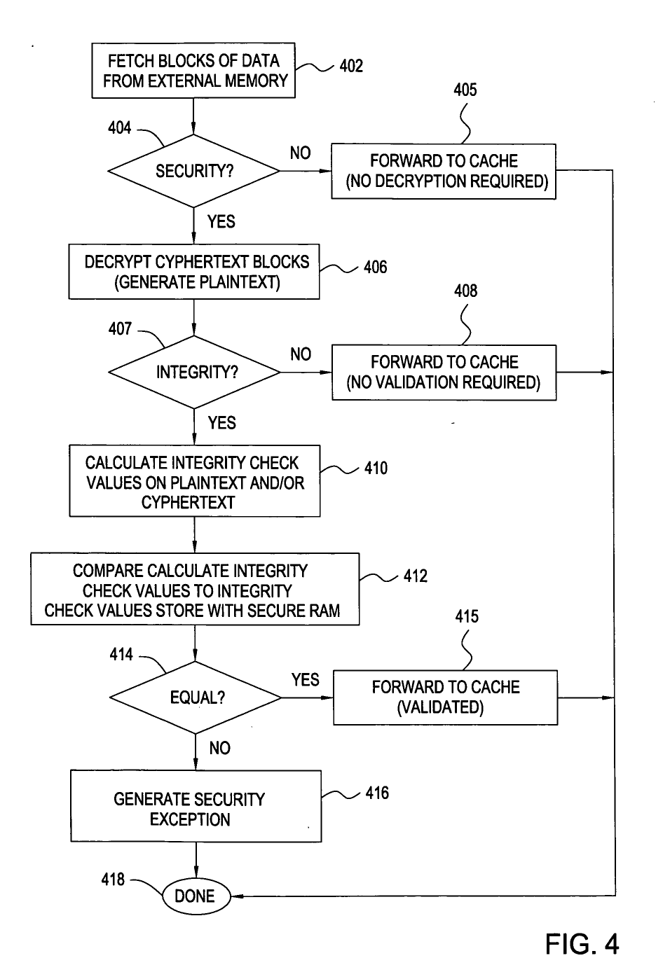

FIG. 2 is a block diagram that illustrates the flow of both secure and non-secure data through the CPU, in accordance with one embodiment of the present invention, for example, as data (e.g., a cache line) is read into the cache from main memory and written out from the cache to main memory. While not shown, flow control logic configured to identify and route secure and non-secure data in accordance with FIG. 2 may be included in the FSB interface 120. Components in FIG. 2 may be described with simultaneous reference to FIGS. 3 and 4, which illustrate exemplary operations 300 and 400, respectively, for writing and reading secure data to and from external memory.

The operations 300 begin, at step 302, by receiving a block of data (e.g., a cache line) to write out to external memory. Note that data received from cache will typically be unencrypted (plaintext) regardless of whether the data is secure or non-secure. If the data is not secure, as determined at step 304, the plaintext data is written directly out to external memory, at step 306. Any suitable technique may be utilized to determine if the data is secure. As an example, a specific address range may be reserved for secure data. As another example, secure data may be identified by one or more bit settings in a page table entry, for example, indicating a corresponding cache line is secure.

In any case, if the data is secure, the plaintext data is encrypted, at step 308. For example, as illustrated in FIG. 2, the plaintext data may be routed to an encryption engine 152 of the security component 150 for encryption. The encryption engine 152 encrypts the secure data and returns the secure data encrypted (as ciphertext). At step 310, the ciphertext data is stored in external memory. For some embodiments, secure data may be stored with or without integrity, meaning an integrity check value (ICV) will or will not be calculated and used to detect tampering thereto. For some embodiments, one or more a range of memory may be reserved for secure data, for which integrity should be enabled. For other embodiments, one or more page table bits may be used to specify integrity should be enabled.

In any case, as illustrated in FIG. 2, the security component 150 may include a validation component 170 configured to generate integrity check values (ICVs) on secure blocks of data being written out to external memory. As will be described in greater detail below, depending on the particular embodiment, ICVs may be calculated as a function of blocks of secure data in either unencrypted form (plaintext), encrypted form (ciphertext), or a combination of the two. By making the ICV dependent, at least in part, on the plaintext value, the likelihood of a hacker making changes to the ciphertext (e.g., changing just a few select bits, commonly referred to as bit-fiddling) that would result in the same ICV is reduced.

### Storing Integrity Check Values in Internal Secure Ram

Referring back to FIG. 3, if integrity is not enabled, as determined at step 311, the operations terminate, at step 316. On the other hand, if integrity is enabled, an integrity check value (ICV) is calculated, at step 312, based on the secure data in plaintext and/or ciphertext form. At step 314, the integrity check value is stored in internal secure random access memory (RAM).

As illustrated in FIGS. 1 and 2, the CPU 110 may include an internal secure RAM 160 to hold security metadata 162 utilized in encrypting secure data 142, such as the ICVs 164 generated by the validation component 170 during write-out. The secure RAM 160 may comprise any suitable type RAM, such as static RAM (SRAM), dynamic RAM (DRAM), and the like. As previously described, the secure RAM 160 may be inaccessible via external pins and, as such, security metadata 162 stored therein may therefore be inaccessible to hackers. Accordingly, for some embodiments, storing security metadata 162 in secure RAM 160 may provide a greater level of security than conventional systems that store security metadata 162 in external memory, with encrypted secure data.

Due to the limitations in silicon real estate, the size of the secure RAM 160 is typically much less than the available size of external memory. Accordingly, systems utilizing secure RAM 160 may be able to support the storage of less total secure data than systems storing security metadata externally. While systems that store secure metadata externally may be able to protect a larger volume of secure data, additional security features may be required, in an effort to ensure the externally-stored security metadata is encrypted and not useful to hackers. While often effective, these additional security features may add complexity and cost to such systems. Therefore, storing security metadata 162 in secure RAM 160 may result in simpler designs and less expensive systems.

As an illustrative example, for some embodiments, a 64 kB secure RAM 160 may be able to store 32 k 2 byte (16 bit) integrity check values (ICVs), with each ICV calculated on a 128 byte block of secure data. Accordingly, such embodiments may be able to protect (and detect tampering with) 4 MB of external memory (32 k×128 Bytes). It should be noted that larger volumes of data may still be encrypted, albeit without tamper detection provided by ICVs. Of course, greater volumes of data may be protected (with ICVs) by increasing the size of the SRAM, but at the expense of available chip real estate. Further, the size of the ICVs and/or size of blocks of data on which the ICVs are calculated may also be varied, with corresponding tradeoffs in security (in general, but with some limit, the greater the number of bits used for an ICV relative to the block size, the less likely it is different blocks of data will result in the same ICV). In other words, the exact size of SRAM, number of bits used for an ICV, and block size are all design parameters that will affect the total amount of data that may be protected by any particular embodiment.

### Retrieving Secure Data

FIG. 4 is a flow diagram of exemplary operations 400, that illustrate how the ICVs stored in secure RAM 160 may be utilized during retrieval of secure data. The operations begin, at step 402, by fetching a block of data from external memory. If the data is not secure, as determined at step 404, the data is forwarded on to the cache, at step 405, as no decryption is required.

If the data is secure, however, the data is ciphertext and, therefore, is decrypted, at step 406. For example, referring back to FIG. 2, the secure ciphertext data may be routed to a decryption engine 154 of the security component 150 for decryption. The decryption engine 154 decrypts the secure data and returns the secure data decrypted (as plaintext). If integrity is not enabled, as determined at step 407, the (plaintext) secure data is forwarded to cache, as no validation is required.

If integrity is enabled, however, an integrity check value (ICV) is calculated, at step 410, based on the secure data in plaintext and/or ciphertext form, depending on how the ICV was previously calculated when the secure data was written out. At step 412, the ICV previously calculated when the secure data was written out is retrieved from secure RAM 160 and compared with the newly calculated ICV value.

If the new and previously stored ICVs are equal, as determined at step 414, the secure data is validated, indicating it is unlikely the secure data was tampered with. Therefore, the secure plaintext data is forwarded to cache, at step 415. On the other hand, a mismatch in ICVs indicates the secure data has been tampered with and a security exception is generated, at step 416. Various events may be triggered by the security exception, depending on the particular embodiment. For example, for some embodiments, the system may not allow further data to be read from external memory until a reset event, such as a power-on-reset, occurs which may at least slow a hackers attempts to disrupt system operations. In any case, the operations 400 terminate, at step 418.

### Location and Time Sensitivity

As previously described, in some cases, hackers may attempt to circumvent tamper detection based on ICVs by what are commonly referred to as relocation and replay attacks. In these types of attacks, one or more blocks of secure data are not altered, but rather copied moved to a different location in external memory (relocation attack) or copied and used to replace data in the same location later in time (replay attack), with the hopes that, in either case, the data will result in the same ICV, thus the relocation or replay will not be detected. However, by storing ICVs internally in secure RAM 160, the ICVs are not made available to the hacker. As a result, a hacker attempting a relocation or replay attack may be able to copy the data, but not the ICV generated on the data. Thus, when such copied data (relocated in memory or time) is read back, the ICV retrieved from secure RAM 160 will likely not match the ICV generated on the retrieved data.

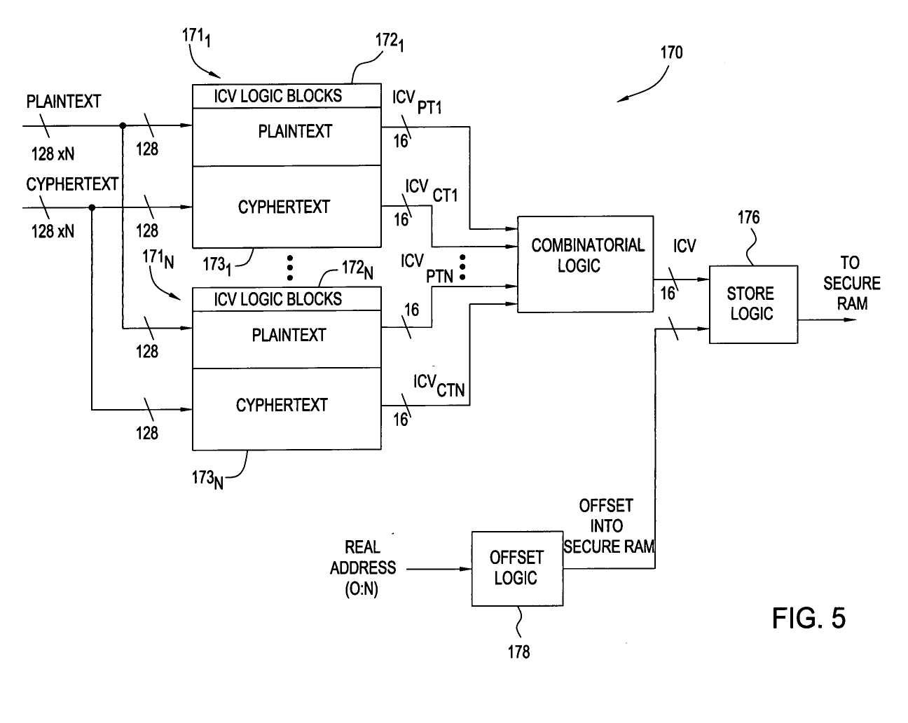

For some embodiments, ICVs are stored in the secure RAM 160 at locations selected based on addresses of the corresponding blocks of secure data and, possibly, additional page table bits. As illustrated in FIG. 5, a validation component 170 may include logic blocks 171 for generating ICVs based on plaintext and/or ciphertext secure data. In some cases, each logic block 171 may include a plaintext logic block 172 to generate an intermediate ICV_{PT} (denoted ICV_{PT1 . . . PTN}) based on plaintext (unencrypted) portions of a block of secure data, as well as a ciphertext logic block 173 to generate an intermediate ICV_{CT} (denoted ICV_{CT1 . . . CTN}) based on ciphertext (encrypted) portions of the block of secure data.

As illustrated, the intermediate plaintext and ciphertext ICVs may be combined by combinatorial logic 174 to generate a final ICV. For example, assuming N=8, 16-bit intermediate ICVs may be generated based on 128 bit portions of a 1024 bit block of secure data and combined into a final 16-bit ICV. The logic blocks 171 may actually be multiple blocks in parallel or a single block through which 128-bit portions of (plaintext and/or ciphertext) secure data are pipelined.

In any case, offset logic 178 may be utilized to calculate an offset value into the secure RAM 160 based on a real address (RA[0:N]) of the secure block. For some embodiments, the offset value may also be calculated based on additional page table bits. In any cases, the calculated ICV and offset value may be provided to store logic 176, which may be configured to store the calculated ICV in the secure RAM 160 at a location based on the offset value.

### Conclusion

Storing security metadata, such as integrity check values (ICVs), in internal secure RAM, rather than externally with encrypted data, may prevent access to such metadata by hackers and possible use to their advantage. As a result, systems employing encryption may be made even more secure against attacks by hackers.

While the foregoing is directed to embodiments of the present invention, other and further embodiments of the invention may be devised without departing from the basic scope thereof, and the scope thereof is determined by the claims that follow.

What is claimed is:

1. A method of handling secure data passed between a processor and memory external to the processor, comprising:
receiving a secure block of data to be written to the memory external to the processor;
encrypting the secure block of data;
generating a first integrity check value as a function of the received block of secure data;
storing the secure block of data, in encrypted form, in the memory external to the processor; and
storing the first integrity check value in memory internal to the processor.

2. The method of claim 1, wherein generating the first integrity check value as a function of the block of secure data comprises generating an integrity check value as a function of the secure block of data subsequent to encryption.

3. The method of claim 2, wherein generating the first integrity check value as a function of the block of secure data comprises generating an integrity check value as a function of the secure block of data both prior to and after encryption.

4. The method of claim 1, wherein storing the first integrity check value in memory internal to the processor comprises:
calculating an offset value as a function of an address of the secure block of data; and
storing the first integrity check value at a location in the memory internal to the processor based on the calculated offset value.

5. The method of claim 1, wherein receiving the secure block of data comprises receiving a cache line to be written out to the external memory.

6. The method of claim 1, further comprising:
retrieving the secure block of data, in encrypted form, from the memory external to the processor;
decrypting the secure block of data;
generating a second integrity check value as a function of the retrieved block of secure data;
retrieving the first integrity check value from the memory internal to the processor;
comparing the first and second integrity check values; and
if the first and second integrity check values match, forwarding the retrieved block of secure data, in decrypted form, to a cache.

7. The method of claim 6, further comprising, if the first and second integrity check values do not match, generating a security exception.

8. The method of claim 6, wherein generating the second integrity check value as a function of the retrieved block of secure data comprises generating an integrity check value as a function of the retrieved block secure block of data both prior to and after decryption.

9. A method of handling data passed between a processor and memory external to the processor, comprising:
receiving a block of data to be written to the memory external to the processor;
determining if the block of data is secure;
if the block of data is not secure, writing the block of data to the memory external to the processor; and
if the block of data is secure,
encrypting the secure block of data;
generating an integrity check value as a function of the received block of secure data;
storing the secure block of data, in encrypted form, in the memory external to the processor; and
storing the integrity check value in memory internal to the processor.

10. The method of claim 9, wherein determining if the block of data is secure comprises examining an address of the block of data.

11. The method of claim 9, wherein determining if the block of data is secure comprises one or more bit settings in a page table entry.

12. A device for encrypting blocks of data to be stored in memory external to the device, comprising:
an internal random access memory (RAM);
an encryption engine configured to encrypt secure blocks of data to be stored in the external memory; and
a validation component configured to generate integrity validation codes as a function of secure blocks of data and store the integrity validation codes in the internal RAM.

13. The device of claim 12, wherein the internal RAM is not accessible externally from the device.

14. The device of claim 12, wherein the validation component is configured to store an integrity validation code at a location in the internal RAM determined as a function of an address of a corresponding block of secure data on which the integrity validation code is generated.

15. The device of claim 12, wherein the validation component is configured to store an integrity validation code at a location in the internal RAM determined as a function of one or more page table bits.

16. The device of claim 12, wherein the validation component is further configured to:
generate new integrity check values on secure blocks of data retrieved from the external memory;
compare the new integrity check values to previously generated integrity check values stored in the internal RAM; and
generate a security exception in response to detecting a mismatch between a new integrity check value and a previously generated integrity check value.

17. The device of claim 16, wherein the validation component is configured to forward the retrieved secure block of data to a cache only if the new and previously generated integrity check value match.

18. A system on a chip (SOC), comprising:
one or more processor cores;
a cache accessible by the one or more processor cores;
an internal random access memory (RAM), wherein the internal RAM is not accessible externally from the SOC;
an encryption engine configured to encrypt secure blocks of data received from the cache and to be stored in the external memory; and
a validation component configured to generate integrity validation codes as a function of secure blocks of data and store the integrity validation codes in the internal RAM.

19. The SOC of claim 18, wherein the validation component is configured to generate integrity validation codes as a function of secure blocks of data prior to encryption.

20. The SOC of claim 18, wherein the validation component is configured to store an integrity validation code at a location in the internal RAM determined as a function of an address of a corresponding block of secure data on which the integrity validation code is generated.

21. The SOC of claim 18, wherein the validation component is further configured to generate a new integrity check value on a secure block of data retrieved from the external memory, compare the new integrity check value to a previously generated integrity check value stored in the internal RAM, and allow the retrieved secure block of data to pass to the cache only if the new and previously generated integrity check value match.
